(19) United States
(12) Patent Application Publication
(10) Pub. No.: US 2007/0242065 A1
(43) Pub. Date: Oct. 18, 2007

(54) TARGET ACQUISITION TRAINING SYSTEM AND METHOD

(76) Inventors: Brian M. O'Flynn, Victoria (CA); James A. Bacon, Bourbonnais, IL (US); James D. English, Newton, MA (US); Justin C. Keesling, Vail, AZ (US); John J. Wiseman, Los Angeles, CA (US)

Correspondence Address: HOLLAND & KNIGHT LLP, 10 ST. JAMES AVENUE, 11th Floor, BOSTON, MA, 02116-3889, US

(21) Appl. No.: 11/733,483

(22) Filed: Apr. 10, 2007

Related U.S. Application Data
(60) Provisional application No. 60/792,586, filed on Apr. 18, 2006.

(51) Int. Cl. G06F 15/00; G06T 15/00

(52) U.S. Cl. 345/419; 704/200

(57) ABSTRACT

A method, computer program product, and system for receiving an object descriptor from a user. The object descriptor is processed to associate the object descriptor with one of a plurality of synthetic objects, thus defining an associated synthetic object. At least a portion of a synthetic three-dimensional environment is scanned for the existence of the associated synthetic object. Feedback is provided to the user concerning the existence of the associated synthetic object within the synthetic three-dimensional environment.

### RELATED APPLICATIONS

This application claims the priority of the following application, which is herein incorporated by reference: U.S. Provisional Application No. 60/792,586; filed 18 Apr. 2006, entitled: “Joint Terminal Attack Controller Wargame Using 3d Spatial-Reasoning”.

### TECHNICAL FIELD

This disclosure relates to training processes and, more particularly, to training processes for use in synthetic three-dimensional environments. This disclosure also relates to virtual reality entertainment in a synthetic three-dimensional environment.

### BACKGROUND

During military operations, target spotters may locate targets for attack by aircraft. For example, covert or overt spotters may use voice communications and light sources that emit visible/invisible light to designate a target for attack. Aircraft may then acquire and attack the designated target. Unfortunately, real-world training of the spotters tends to be an expensive and risky proposition, as it requires the use of aircraft and munitions. Further, computer-based training of spotters only produced marginal results (at best).

### SUMMARY OF DISCLOSURE

In a first implementation of this disclosure, a method includes receiving an object descriptor from a user. The object descriptor is processed to associate the object descriptor with one of a plurality of synthetic objects, thus defining an associated synthetic object. At least a portion of a synthetic three-dimensional environment is scanned for the existence of the associated synthetic object. Feedback is provided to the user concerning the existence of the associated synthetic object within the synthetic three-dimensional environment.

One or more of the following features may also be included. The object descriptor may be an analog speech-based object descriptor. Processing the object descriptor may include converting the analog speech-based object descriptor into a digital object descriptor. The feedback may be digital feedback. Providing feedback to the user may include converting the digital feedback into analog speech-based feedback. The analog speech-based feedback may be provided to the user.

The synthetic three-dimensional environment may include a plurality of unique synthetic objects. Each unique synthetic object may be associated with a unique characteristic. The unique characteristic may be a unique color. Processing the object descriptor may include associating the associated synthetic object with one of a plurality of unique colors, thus defining an associated unique color. Scanning at least a portion of the synthetic three-dimensional environment for the existence of the associated synthetic object may include scanning at least a portion of the synthetic three-dimensional environment for the existence of the associated unique color. At least one of the plurality of synthetic objects may be representative of one or more topographical objects. The one or more topographical objects may include at least one man-made object and/or at least one natural object.

In another implementation of this disclosure, a computer program product resides on a computer readable medium and has a plurality of instructions stored on it. When executed by a processor, the instructions cause the processor to perform operations including receiving an object descriptor from a user. The object descriptor is processed to associate the object descriptor with one of a plurality of synthetic objects, thus defining an associated synthetic object. At least a portion of a synthetic three-dimensional environment is scanned for the existence of the associated synthetic object. Feedback is provided to the user concerning the existence of the associated synthetic object within the synthetic three-dimensional environment.

One or more of the following features may also be included. The object descriptor may be an analog speech-based object descriptor. Processing the object descriptor may include converting the analog speech-based object descriptor into a digital object descriptor. The feedback may be digital feedback. Providing feedback to the user may include converting the digital feedback into analog speech-based feedback. The analog speech-based feedback may be provided to the user.

The synthetic three-dimensional environment may include a plurality of unique synthetic objects. Each unique synthetic object may be associated with a unique characteristic. The unique characteristic may be a unique color. Processing the object descriptor may include associating the associated synthetic object with one of a plurality of unique colors, thus defining an associated unique color. Scanning at least a portion of the synthetic three-dimensional environment for the existence of the associated synthetic object may include scanning at least a portion of the synthetic three-dimensional environment for the existence of the associated unique color. At least one of the plurality of synthetic objects may be representative of one or more topographical objects. The one or more topographical objects may include at least one man-made object and/or at least one natural object.

In another implementation of this disclosure, a target acquisition system includes: a display screen; a microphone assembly; and a data processing system coupled to the display screen and the microphone assembly. The data processing system is configured to render, on the display screen, a first-party view of a synthetic three-dimensional environment for a user. An analog speech-based object descriptor is received, via the microphone assembly, from the user. The analog speech-based object descriptor is processed to associate the analog speech-based object descriptor with one of a plurality of synthetic objects, thus defining an associated synthetic object. A second-party view of the synthetic three-dimensional environment is scanned for the existence of the associated synthetic object. Analog speech-based feedback is provided to the user concerning the existence of the associated synthetic object within the second-party view of the synthetic three-dimensional environment.

One or more of the following features may also be included. The synthetic three-dimensional environment may include a plurality of unique synthetic objects, wherein each unique synthetic object is associated with a unique characteristic. The unique characteristic may be a unique color. Processing the analog speech-based object descriptor may include associating the associated synthetic object with one of a plurality of unique colors, thus defining an associated unique color.

Scanning the second-party view of the synthetic three-dimensional environment for the existence of the associated synthetic object may include scanning the second-party view of the synthetic three-dimensional environment for the existence of the associated unique color. At least one of the plurality of synthetic objects may be representative of one or more topographical objects. The one or more topographical objects may include at least one man-made object and/or at least one natural object.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a target acquisition training process executed in whole or in part by a computer;

FIG. 2 is a first topographical map of the synthetic three-dimensional environment;

FIG. 3 is a flowchart of the target acquisition training process of FIG. 1;

FIG. 4 is a diagrammatic view of a user field of view rendered (in whole or in part) by the target acquisition training process of FIG. 1;

FIG. 5 is a diagrammatic view of a pilot field of view rendered (in whole or in part) by the target acquisition training process of FIG. 1;

FIG. 6 is a second topographical map of the synthetic three-dimensional environment; and

FIG. 7 is a diagrammatic view of another pilot field of view rendered (in whole or in part) by the target acquisition training process of FIG. 1;

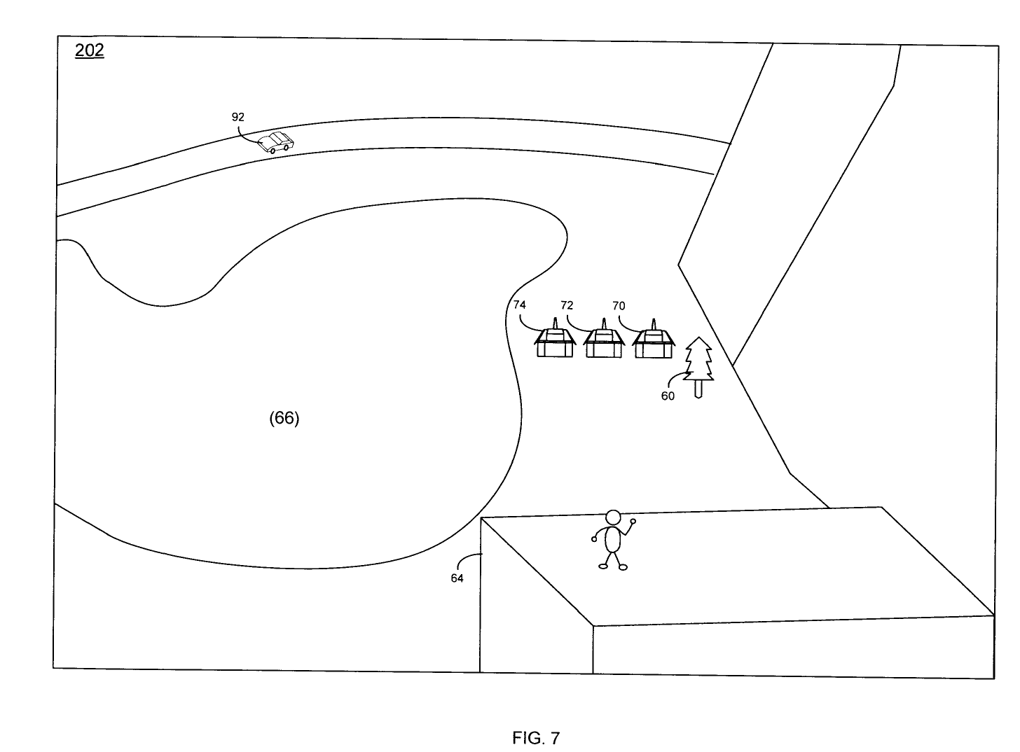

Like reference symbols in the various drawings indicate like elements.

### DETAILED DESCRIPTION OF THE PREFERRED EMBODIMENTS

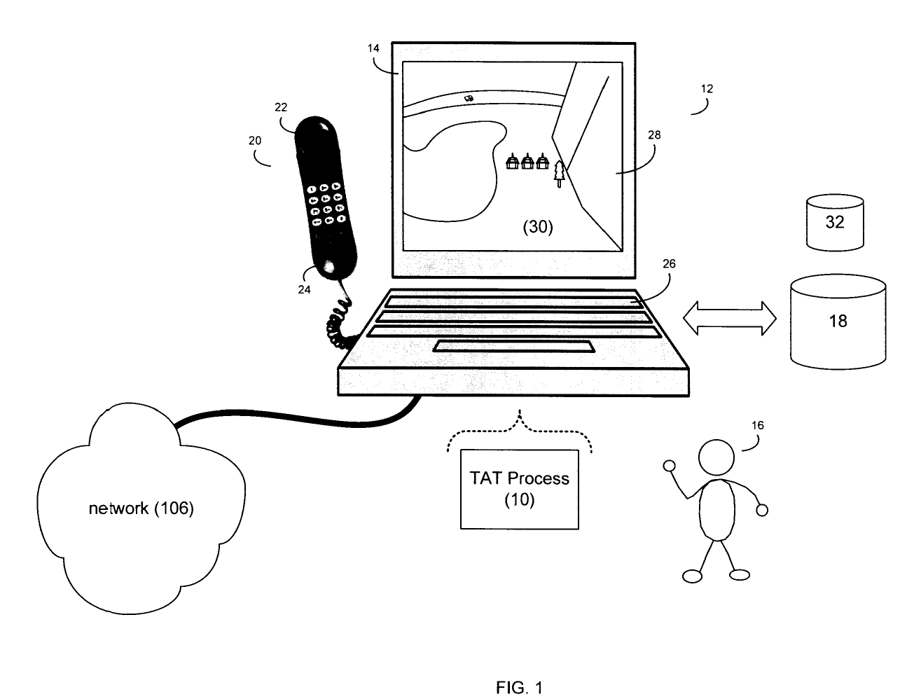

Referring to FIG. 1, there is shown a target acquisition training (i.e., TAT) process 10, which may be resident on (in whole or in part) and executed by (in whole or in part) computing device 12 (e.g., a laptop computer, a notebook computer, a single server computer, a plurality of server computers, a desktop computer, or a handheld device, for example). Computing device 12 may include a display screen 14 for displaying images rendered by TAT process 10. As will be discussed below in greater detail, TAT processes 10 may allow user 16 to be trained in the procedures required to locate a target for engagement by e.g., an aircraft, a tank, or a boat. Computing device 12 may execute an operating system (not shown), examples of which may include but are not limited to Microsoft Windows XP™, Microsoft Windows Mobile™, and Redhat Linux™.

The instruction sets and subroutines of TAT process 10 and the operating system (not shown), which may be stored on a storage device 18 coupled to computing device 12, may be executed by one or more processors (not shown) and one or more memory architectures (not shown) incorporated into computing device 12. Storage device 18 may include, but is not limited to, a hard disk drive, a tape drive, an optical drive, a RAID array, a random access memory (RAM), or a read-only memory (ROM).

A handset 20, which may include a speaker assembly 22 and a microphone assembly 24, may be coupled to computing device 12 via e.g., a USB (i.e., universal serial bus) port incorporated into computing device 12. Microphone assembly 24 within handset 20 and/or keyboard 26 may be used by user 16 to provide commands to TAT process 10. Further, speaker assembly 22 within handset 20 and/or display 28 may be used by TAT process 10 to provide feedback/information to user 16.

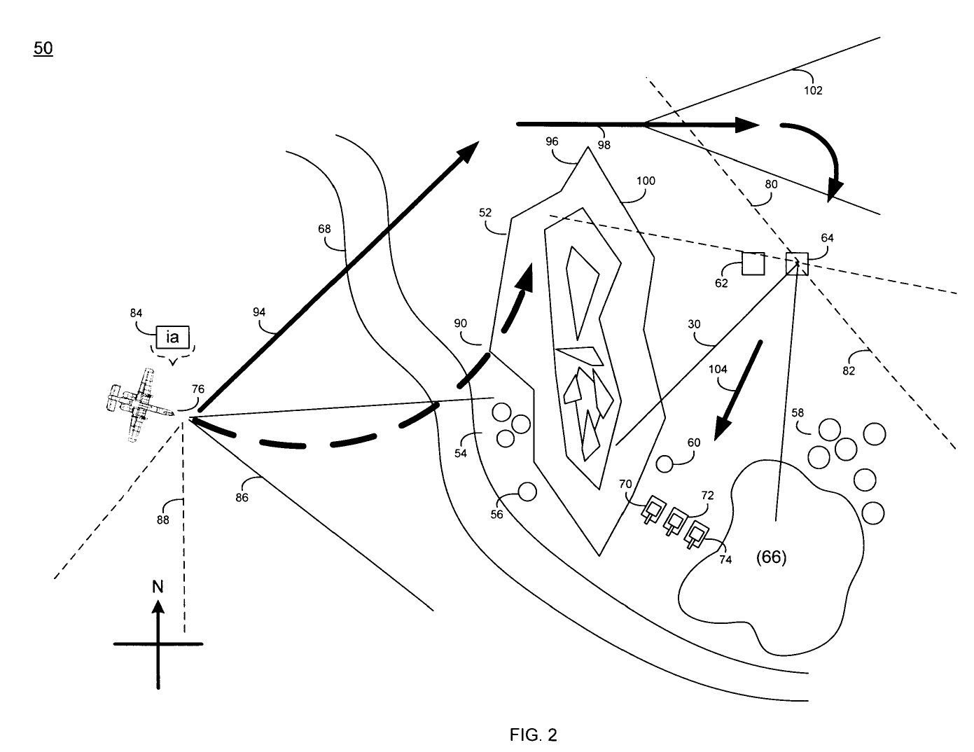

When executed by computing device 12, TAT process 10 may render a user field of view 30 of a synthetic three-dimensional environment. Referring also to FIG. 2, synthetic three-dimensional environment 50 may be a computer-generated three-dimensional space representative of a military operations theater. For example, synthetic three-dimensional environment 50 may include a plurality of synthetic objects, such as man-made topographical objects (e.g., buildings and vehicles) and natural topographical objects (e.g., mountains and trees). For illustrative purposes, synthetic three-dimensional environment 50 is shown (in this embodiment) to include mountains 52, trees 54, 56, 58, 60, buildings 62, 64, lake 66, road 68, tanks 70, 72, 74, and aircraft 76.

Each of the synthetic objects (e.g., objects 52, 54, 56, 58, 60, 62, 64, 66, 68, 70, 72, 74, 76) included within synthetic three-dimensional environment 50 may be a three-dimensional object that defines a three-dimensional space within synthetic three-dimensional environment 50. For example, buildings 62, 64 may define a length, a width, and a height within three-dimensional environment 50.

When TAT process 10 renders synthetic three-dimensional environment 50, synthetic three-dimensional environment 50 may be a dynamic environment in which e.g., vehicles drive along road 68, tanks 70, 72, 74 move throughout the landscape of synthetic three-dimensional environment 50, and aircraft 76 flies throughout synthetic three-dimensional environment 50.

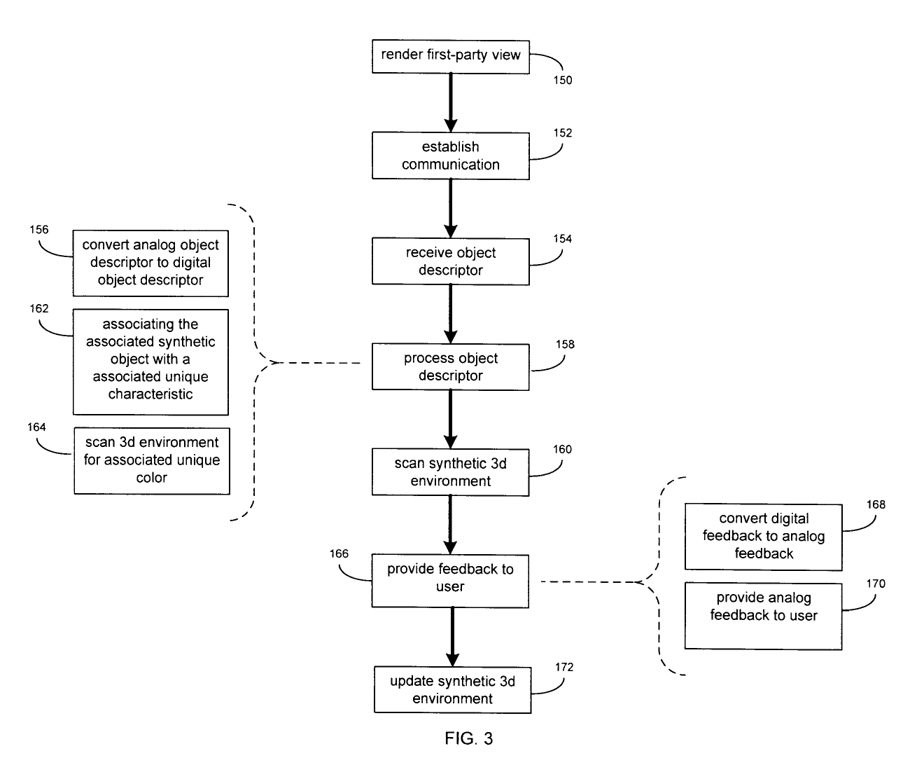

Referring also to FIG. 3, TAT process 10 may render 150, on display screen 14, user field of view 30 of synthetic three-dimensional environment 50 for an avatar of user 16. Specifically, while user 16 is a human being that is being trained in the procedures required to locate a target for engagement by e.g., an aircraft, a synthetic representation of user 16 (i.e., an avatar) is positioned within synthetic three-dimensional environment 50 and is manipulatable by user 16. Synthetic three-dimensional environment 50 may function as a virtual world through which the avatar of user 16 may maneuver and travel in a fashion similar to that of many popular first-person shooter games (e.g., Doom™ by Id Software™ and Quake™ by Id Software™). Accordingly, as the avatar of user 16 maneuvers through synthetic three-dimensional environment 50, user field of view 30 may change to illustrate what the avatar of user 16 is “seeing” within synthetic three-dimensional environment 50.

For example, assume for illustrative purposes that the avatar of user 16 is positioned on top of building 64 (FIG. 2) and is looking in a south-southwest direction, as represented by user field of view 30 (FIG. 2). Assume that building 64 is several stories high and thus provides a high-enough vantage point to allow the avatar of user 16 to have an unobstructed view of e.g., tanks 70, 72, 74. As discussed above, synthetic three-dimensional environment 50 functions as a virtual three-dimensional world through which the avatar of user 16 may maneuver. Further, user field of view 30, as rendered by TAT process 10, represent the view that the avatar of user 16 “sees”.

When TAT process 10 is rendering 150 user field of view 30, the appearance of user field of view 30 may be based on numerous parameters, examples of which may include but are not limited to, the elevation of the avatar of user 16, the direction in which the avatar of user 16 is looking, the angle of inclination (e.g., the avatar of user 16 is looking upward, the avatar of user 16 is looking downward), the elevation of the objects to be rendered within user field of view 30, and the location and ordering (front-to-back) of the objects to be rendered within user field of view 30. Accordingly, if the avatar of user 16 “moves” within synthetic three-dimensional environment 50, user field of view 30 may be updated to reflect the new field of view. For example, if the avatar of user 16 rotates 90° in a clockwise direction, a new user field of view (e.g., user field of view 80) may be defined and TAT process 10 may update the user field of view to reflect what the avatar of user 16 “sees” when looking in a west-northwest direction. Further, if the avatar of user 16 rotates 90° in a counterclockwise direction, a new field of view (e.g., user field of view 82) may be defined and TAT process 10 may update the user field of view to reflect what the avatar of user 16 “sees” when looking in a east-southeast direction.

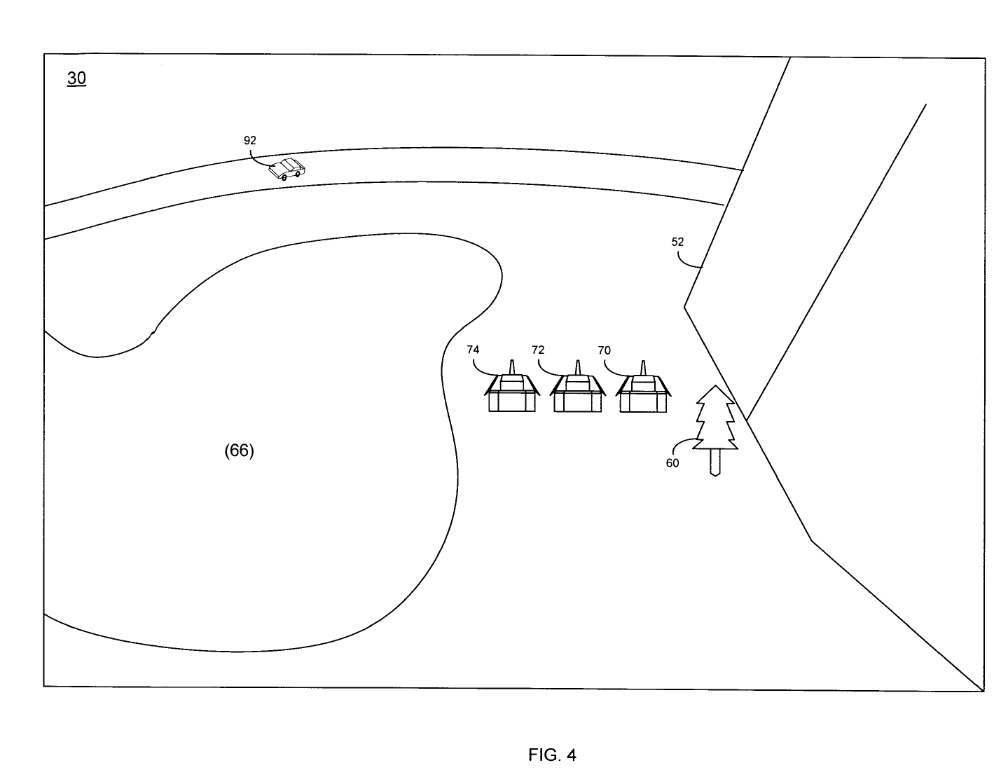

Referring also to FIG. 4 and assuming a south-southwest user field of view 30, user field of view 30 may include a portion of mountains 52, tree 60, lake 66, and tanks 70, 72, 74. Assume that synthetic three-dimensional environment 50 is representative of a military theater and the avatar of user 16 is a soldier who is functioning as a spotter, i.e., a soldier that locates an enemy target for the purpose of having military equipment engage and destroy the enemy target.

Assume for illustrative purposes that the objective of user 16 was to locate tanks 70, 72, 74. Further, assume that after maneuvering the avatar of user 16 through synthetic three-dimensional environment 50 and that after searching for such tanks, user 16 locates tanks 70, 72, 74 within user field of view 30. As discussed above, user field of view 30 is what the avatar of user 16 is “seeing” within synthetic three-dimensional environment 50. Assume that user 16 is in radio communication with aircraft 76, e.g., a Fairchild-Republic A-10 Thunderbolt II, which is a single-seat, twin-engine aircraft designed for e.g., attacking tanks, armored vehicles, and other ground targets and providing close air support of troops. Once tanks 70, 72, 74 are located, user 16 may contact aircraft 76 using e.g., handset 20 and describe the location of the targets (e.g., tanks 70, 72, 74) so that aircraft 76 may acquire and engage the targets.

Aircraft 76 may be flown by a intelligent agent 84, examples of which may include but are not limited to a synthetic pilot and a synthetic crew. TAT process 10 may allow user 16 to be trained in the process of locating targets by providing instructions concerning those targets (e.g., tanks 70, 72, 74) to e.g., the intelligent agent 84 that is “piloting” synthetic aircraft 76. Specifically, as TAT process 10 allows user 16 to provide location instructions to intelligent agent 84 (i.e., as opposed to a human pilot) who is piloting synthetic aircraft 76 (i.e., as opposed to a real aircraft), user 16 may be trained in the process of locating targets and providing location instructions to e.g., pilots without the costs and risks associated with piloting and utilizing real aircraft.

Once user 16 locates the intended targets (e.g., tanks 70, 72, 74), user 16 (via handset 20) may establish 152 communication with the intended engager of the target (e.g., aircraft 76). Accordingly, user 16 (via microphone assembly 24 included within handset 20) may use predetermined commands to establish 152 communication with intelligent agent 84 piloting synthetic aircraft 76. For example, once targets 70, 72, 74 are located by user 16, user 16 may say e.g., “A10 Warthog: Acknowledge” into the microphone assembly 24 of handset 20.

TAT process 10 may process this speech-based command (e.g., “A10 Warthog: Acknowledge”), which may be converted from an analog command to a digital command using an analog-to-digital converter (not shown). The analog-to-digital converter may be a hardware circuit (not shown) incorporated into handset 20 and/or computing device 14 or may be a software process (not shown) that is incorporated into TAT process 10 and is executed by one or more processors (not shown) and one or more memory architectures (not shown) incorporated into computing device 12.

Once converted into a usable format (e.g., a digital command), TAT process 10 may examine the command received and compare it to a database of known commands stored within command repository 32. An example of command repository 32 may include, but is not limited to, a database (e.g., an Oracle™ database, an IBM DB2™ database, a Sybase™ database, a Computer Associates™ database, and a Microsoft Access™ database). Command repository 32 may reside on storage device 18.

Continuing with the above-stated example in which the command “A10 Warthog: Acknowledge” is received, TAT process 10 may compare this command to the various known commands included within command repository 32. Assume that once TAT process 10 performs the required comparison, it is determined that “A10 Warthog” is a call sign for aircraft 76 and “Acknowledge” is a command to establish 152 a communication session between intelligent agent 84 (who is piloting aircraft 76) and user 16.

Intelligent agent 84 may acknowledge receipt of the call sign (i.e., “A10 Warthog”) and the command (i.e., “Acknowledge”) by issuing an acknowledgement response (e.g., “A10 Warthog Roger”). The manner in which intelligent agent 84 responds to user 16 may be governed by one or more acceptable responses defined within command repository 32. For example, when user 16 initiates a communication session, the acceptable response for intelligent agent 84 (as defined within command repository 32) may include a combination of the call sign of the intelligent agent (e.g., “A10 Warthog”) and a general acknowledgement (e.g., “Roger”). While these commands and responses are exemplary, they are provided for illustrative purposes only and are not intended to be a limitation of this disclosure, as the nomenclature of dialog between user 16 and e.g., intelligent agent 84 may be varied depending on design criteria and specific application.

Once a communication session is established 152 between intelligent agent 84 and user 16, a dialog may occur in which user 16 asks questions and issues commands to intelligent agent 84 to determine the location of intelligent agent 84 and guide synthetic aircraft 76 to the intended targets (i.e., tanks 70, 72, 74). As intelligent agent 84 is a computer-based model of the pilot who is piloting synthetic aircraft 76, intelligent agent 84 has a defined field of view (i.e., pilot field of view 86) similar to that of a human pilot.

Pilot field of view 86 may be based on numerous parameters, examples of which may include but are not limited to, the elevation of aircraft 76, the direction in which aircraft 76 is traveling, the angle of inclination of aircraft 76, the direction in which intelligent agent 84 is looking, the angle on inclination of intelligent agent 84, the elevation of the objects to be rendered within pilot field of view 86, and the location and ordering (front-to-back) of the objects to be rendered within pilot field of view 86. Accordingly, if intelligent agent 84 “moves” within synthetic three-dimensional environment 50, pilot field of view 86 may be updated to reflect the new field of view. For example, if intelligent agent 84 rotates 90° in a clockwise direction, a new field of view (e.g., pilot field view 88) may be defined and TAT process 10 may update the pilot's field of view to reflect what intelligent agent 84 would “see” if they looked out of e.g., the right-side cockpit window of aircraft 76.

Additionally and as in this example, since intelligent agent 84 is the pilot of aircraft 76, pilot field of view 86 may be continuously changing, as aircraft 76 may be continuously moving. Accordingly, TAT process 10 may have aircraft 76 fly in a circular holding pattern 90 until a communication session is established 152 with e.g., user 16 and commands are received from e.g., user 16 requesting intelligent agent 84 to deviate from holding pattern 90. The manner in which aircraft 76 is described as being in a holding pattern is for illustrative purposes only and is not intended to be a limitation of this disclosure. For example, certain types of equipment (e.g., tanks, boats, artillery, helicopters, and non-flying airplanes) need not be in a holding pattern. Accordingly, for these pieces of equipment, the field of view “seen” by the intelligent agent associated with the piece of equipment may be static until communication with user 16 is established 152 and commands are received from user 16.

Continuing with the above-stated example, once communication is established 152, user 16 may issue one or more commands to intelligent agent 84, requesting various pieces of information. For example, user 16 may say e.g., “A10 Warthog: Identify Location and Heading”. Once “A10 Warthog: Identify Location and Heading” is received, TAT process 10 may compare this command to the various command components included within command repository 32. Assume that once TAT process 10 performs the required comparison, it is again determined that “A10 Warthog” is a call sign for aircraft 76 and “Identify Location and Heading” is a command for intelligent agent 84 to identify their altitude, airspeed, heading, and location. As discussed above, the manner in which intelligent agent 84 responds to user 16 may be governed by one or more acceptable responses defined within command repository 32. For example, intelligent agent 84 may acknowledge receipt of the call sign (i.e., “A10 Warthog”) and the command (i.e., “Identify Location and Heading”) by issuing an acknowledgement response (e.g., “A10 Warthog: Elevation: 22,000 feet; Airspeed: 300 knots; Heading 112.5° (i.e., east-southeast); Location Latitude 33.33 Longitude 44.43”).

User 16 may continue to issue commands to intelligent agent 84 to determine the location of aircraft 76 and direct aircraft 76 toward the intended targets (i.e., tanks 70, 72, 74). For example, suppose that being user 16 now knows the location and heading of aircraft 76, user 16 may now wish to visually direct intelligent agent 84 (and, therefore, aircraft 76) to the intended target.

For example, assume for illustrative purposes that at the time that communication is established between intelligent agent 84 and user 16, intelligent agent 84 may be positioned in a manner that results in intelligent agent 84 having field of view 86. To aid intelligent agent 84 in locating the intended target (tanks 70, 72, 74), user 16 may issue a series of commands (e.g., questions, statements and/or instructions) to intelligent agent 84 to determine what intelligent agent 84 can currently “see” within field of view 86. As discussed above, since aircraft 76 is currently cruising at 22,000 feet, the ability of intelligent agent 84 to “see” comparatively small ground targets may be compromised.

Assuming that tanks 70, 72, 74 are Soviet-made T-54 tanks, user 16 (via microphone assembly 24 included within handset 20) may issue the following command “A10 Warthog: Do you see three T-54 tanks?” to TAT process 10. Unlike the above-described commands, this command includes an “object descriptor”, which describes an object that intelligent agent 84 should look for in their field of view (i.e., pilot field of view 86). In this particular example, the “object descriptor” is “T-54”.

Upon receiving 154 the above-described command, TAT process 10 may process this speech-based command (which includes the object descriptor “T-54”), which may be converted 156 from an analog command to a digital command using an analog-to-digital converter (not shown). As discussed above, the analog-to-digital converter may be a hardware circuit (not shown) incorporated into handset 20 and/or computing device 14 or may be a software process (not shown) that is incorporated into TAT process 10 and is executed by one or more processors (not shown) and one or more memory architectures (not shown) incorporated into computing device 12.

Continuing with the above-stated example in which the command “A10 Warthog: Do you see three T-54 tanks?” is received, TAT process 10 may compare the various portions of this command to the various known commands defined within command repository 32. Assume that once TAT process 10 performs the required comparison, it is determined that “A10 Warthog” is a call sign for aircraft 76 and “Do you see three T-54 tanks?” is a question that includes the number “three” and the object descriptor “T-54”.

Once TAT process 10 determines the existence of a known object descriptor (i.e., “T-54”) within the command “A10 Warthog: Do you see three T-54 tanks?”, TAT process 10 may process 158 the object descriptor (i.e., “T-54”) to associate the object descriptor with one of a plurality of synthetic objects. The plurality of synthetic objects and the association of synthetic objects to object descriptors may be stored within command repository 32 (FIG. 1).

A synthetic object is the graphical image/representation of an object descriptor, rendered in the manner in which it would appear within e.g., field of view 30 and/or field of view 86. For example, FIG. 4 is shown to include three images representative of a T-54 tank (namely tanks 70, 72, 74), each of which is the synthetic object associated with the object descriptor “T-54”. Further, synthetic object 60 (i.e., a graphical image/representation of a tree) may be the synthetic object associated with the object descriptor “tree”. Additionally, synthetic object 66 (i.e., a graphical image/representation of a lake) may be the synthetic object associated with the object descriptor “lake”; synthetic object 52 (i.e., a graphical image/representation of a mountain) may be the synthetic object associated with the object descriptor “mountain”; and synthetic object 92 (i.e., a graphical image/representation of a car) may be the synthetic object associated with the object descriptor “car”. Accordingly, a synthetic object (which is typically associated with one or more object descriptors) is the graphical representation of an object within synthetic three-dimensional environment 50.

Once the received object descriptor (i.e., “T-54”) is processed 158 to associate the object descriptor with a synthetic object, a portion of synthetic three-dimensional environment 50 may be scanned 160 to determine whether (or not) the synthetic object associated with the received object descriptor is present within the portion of synthetic three-dimensional environment 50 being scanned. When scanning synthetic three-dimensional environment 50 for the presence of the associated synthetic object, the portion scanned may be the portion viewable by the intelligent agent (e.g., intelligent agent 84) to which user 16 made the inquiry. For example, as user 16 inquired as to whether synthetic agent 84 could “see” any “T-54” tanks, the portion of synthetic three-dimensional environment 50 scanned for the presence of the associated synthetic object may be the portion of synthetic three-dimensional environment 50 viewable by synthetic agent 84, namely field of view 86.

For illustrative purposes, assume that (concerning tanks) there are three possible object descriptors, namely “T-54”, “T-34” and “M1 Abrams” and that each of these three object descriptors is associated with a unique synthetic object. Specifically, the “T-54” and “T-34” synthetic objects are representative of soviet-built tanks and are most likely considered enemy targets. Conversely, the “M1 Abrams” synthetic object is representative of a U.S.-built tank and is most likely indicative of a friendly vehicle.

While, in this example, it is explained that each object descriptor (e.g., “T-54”, “T-34” and “M1 Abrams”) is associated with a unique synthetic object (i.e., a unique graphical representation of the object descriptor within synthetic three-dimensional environment 50), this is for illustrative purposes only and is not intended to be a limitation of this disclosure. Specifically, the correlation of object descriptors to synthetic objects is simply a function of design choice. Specifically and in this example, each of the object descriptors “T-54”, “T-34” and “M1 Abrams” is associated with a unique synthetic object. For illustrative purposes, assume that: object descriptor “T-54” is associated with a corresponding unique synthetic object “T54”; object descriptor “T-34” is associated with a corresponding unique synthetic object “T34”; and object descriptor “M1 Abrams” is associated with a corresponding unique synthetic object “M1Abrams”. However, in order to reduce overheard requirements (e.g., system RAM, system ROM, hard drive space, processor speed) required by TAT process 10, a common synthetic object may be associated with multiple object descriptors. For example, object descriptor “T-54” may be associated with a common synthetic object “Enemy Tank”; object descriptor “T-34” may be associated with the same common synthetic object “Enemy Tank”; and object descriptor “M1 Abrams” may be associated with the common synthetic object “Friendly Tank”. While the use of common synthetic objects reduces overhead requirements (as the database of synthetic objects is smaller and more easily searchable), the resolution of TAT process 10 may be reduced as e.g., synthetic agent 84 may not be able to differentiate between a “T-54” tank and a “T-34” tank (as they both use a common “Enemy Tank” synthetic object).

To facilitate the scanning of synthetic three-dimensional environment 50 (or a portion thereof), each synthetic object may be associated 162 with a unique characteristic. Examples of these unique characteristics may be characteristics that provide a visual uniqueness to a synthetic object, such as a unique color, a unique fill pattern and/or a unique line type.

Assume for illustrative purposes that TAT process 10 associates each synthetic objects with a unique color. For example, a T34 synthetic object (which is associated with the “T-34” object descriptor) may be associated with a light red color; a T54 synthetic object (which is associated with the “T-54” object descriptor) may be associated with a dark red color, and an M1Abrams synthetic object (which is associated with the “M1 Abrams” object descriptor) may be associated with a light blue color. Additionally, assume that in order to reduce overhead requirements, TAT process 10 associates certain types of object descriptors with common synthetic objects. Examples of the types of object descriptors that may be associated with common synthetic objects may include trees, mountains, and roadways (i.e., objects that user 16 will not target for engagement by e.g., aircraft 76). Examples of the types of object descriptors that may be associated with unique synthetic objects may include various types of tanks and artillery pieces, bridges, aircraft, and bunkers (i.e., objects that user 16 may target for engagement by e.g., aircraft 76).

The information correlating object descriptors to synthetic objects, and synthetic objects to colors may be stored within the above-described data repository. An exemplary illustration of such a correlation is shown in the following table:

| object | synthetic | | | |
|---|---|---|---|---|
| descriptor | object | red | green | blue |
| “T-34” | T34 | 255 | 128 | 128 |
| “T-54” | T54 | 255 | 0 | 0 |
| “M1 Abrams” | M1 Abrams | 128 | 128 | 255 |
| “Pine Tree” | Tree | 41 | 163 | 51 |
| “Spruce Tree” | Tree | 41 | 163 | 51 |
| “Mountain” | Mountain | 100 | 100 | 100 |
| “Road” | Road | 77 | 77 | 77 |
| “Highway” | Road | 77 | 77 | 77 |
| “Street” | Road | 77 | 77 | 77 |
| “Lake” | Lake | 23 | 119 | 130 |
| “Pond” | Lake | 23 | 119 | 130 |
| “Building” | Building | 114 | 86 | 100 |

As discussed above, a plurality of non-targetable object descriptors (e.g., “road”, “highway” and “street”) may be associated with a single synthetic object (e.g., Road). Accordingly, within e.g., field of view 86 (i.e., the field of view of aircraft 76), the roads, highways, and streets may all be associated with a common color. However, for object descriptors that user 16 uses to describe targetable entities (e.g., an enemy tank), a unique synthetic object (and, therefore, a unique color) may be associated with each unique object descriptor, thus allowing intelligent agent 84 to differentiate between e.g., a T-34 tank, a T-54 tank, and an M1 Abrams tank.

As discussed above, a portion of synthetic three-dimensional environment 50 may be scanned 160 to determine whether (or not) the synthetic object (i.e., T54) associated with the received object descriptor (i.e., “T-54”) is present within a portion (i.e., field of view 86) of synthetic three-dimensional environment 50. Additionally and as discussed above, each synthetic object (e.g., T54) may be associated with a unique color (e.g., R255, G0, B0). Accordingly, when scanning 160 synthetic three-dimensional environment 50, TAT process 10 may scan 164 for the existence of the unique color associated 162 with the associated synthetic object. For example, upon receiving 154 the object descriptor “T-54” from user 16, TAT process 10 may process 158 object descriptor “T-54” to associate it with synthetic object T54, which is associated 162 with a unique characteristic (e.g., color R255, G0, B0). Accordingly, TAT process 10 may scan 164 field of view 86 for the existence of color R255, G0, B0 to determine whether intelligent agent 84 can “see” the group of three T-54 tanks identified by user 16.

As discussed above, as aircraft 76 is currently cruising at 22,000 feet, the ability of the intelligent agent 84 to “see” comparatively small ground targets may be compromised. Accordingly, simply because the unique color being scanned 164 for is present within e.g., field of view 86, TAT process may require that the existence of the color within field of view 86 be large enough for intelligent agent 84 to “see” the object” For example, when scanning 160 field of view 86, TAT process 10 may require that in order for an object to be “seen” by intelligent agent 84, the color being scanned 160 for within field of view 86 must be found in a cluster at least “X” pixels wide and “Y” pixels high. Therefore, while intelligent agent 84 (who is cruising at 22,000 feet) might see a grounded MiG-29 aircraft, intelligent agent 84 probably would not see the pilot who is standing next to the grounded MiG-29 aircraft.

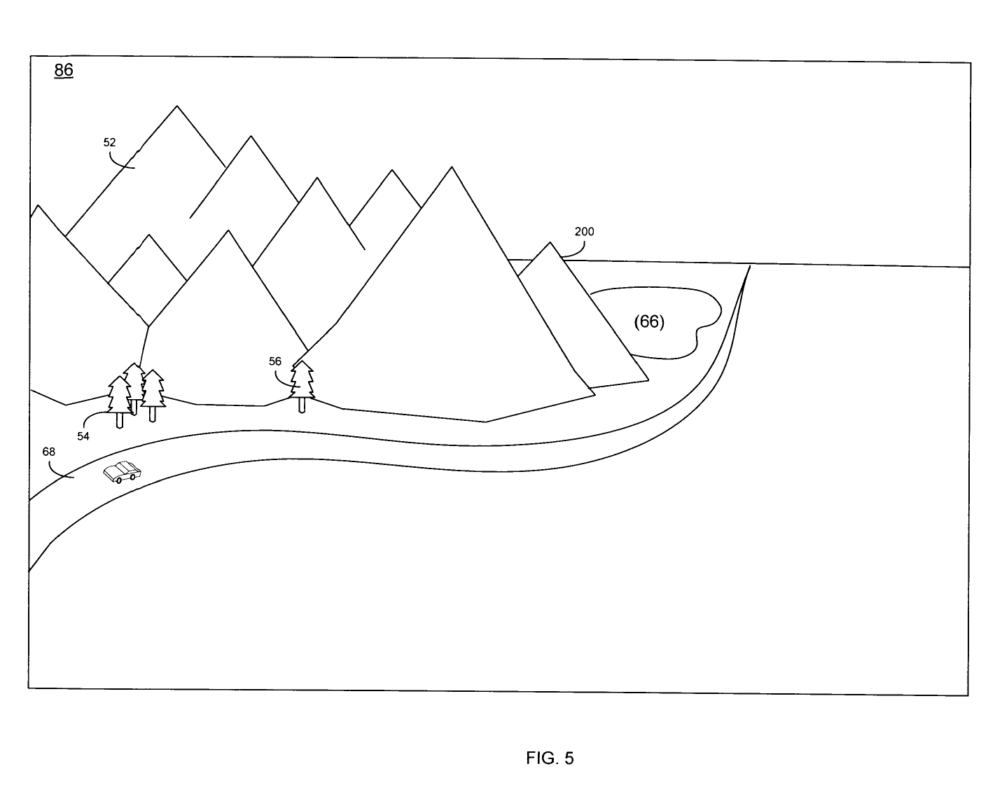

Continuing with the above-stated example in which the command “A10 Warthog: Do you see three T-54 tanks” is received, TAT process 10 may scan 160 pilot field of view 86 for the existence of color R255, G0, B0 (i.e., the color associated with synthetic object T54). Referring also to FIG. 5, pilot field of view 86 is shown to include mountains 52, trees 54, 56, lake 66, and roadway 68. As tanks 70, 72, 74 are obscured behind the southern edge 200 of mountains 52, intelligent agent 84 would not be able to “see” tanks 70, 72, 74. Accordingly, when TAT process 10 scans 160 field of view 86 for the existence of color R255, G0, B0 (i.e., the color associated with synthetic object T54), the associated color would not be found.

TAT process 10 may provide 166 user 16 with feedback concerning the existence of the associated synthetic object (i.e., T54) within synthetic three-dimensional environment 50. Since the scan 160 of synthetic three-dimensional environment 50 would fail to find color R255, G0, B0 (i.e., the color associated with synthetic object T54), TAT process 10 may provide negative feedback to user 16, such as “A10 Warthog: Negative”. The feedback generated by TAT process 10 may be digital feedback and providing 166 feedback to the user may include converting 168 the digital feedback into analog speech-based feedback. Accordingly and in this example, this digital version of “A10 Warthog: Negative” may be converted 168 to analog speech-based feedback, which may be provided 170 to user 16 via e.g., speaker assembly 22 included within handset 20.

The digital feedback may be converted to analog feedback using a digital-to-analog converter (not shown). The digital-to-analog converter may be a hardware circuit (not shown) incorporated into handset 20 and/or computing device 14 or may be a software process (not shown) that is incorporated into TAT process 10 and is executed by one or more processors (not shown) and one or more memory architectures (not shown) incorporated into computing device 12.

Upon receiving negative feedback (i.e., “A10 Warthog: Negative”), user 16 may direct aircraft 76 toward the intended targets (i.e., tanks 70, 72, 74). For example, user 16 (via microphone assembly 24 included within handset 20) may issue the following command “A10 Warthog: Do you see a mountain?” to TAT process 10. This command includes the object descriptor “mountain”.

Again, TAT process 10 may compare the various portions of this command to the various known commands defined within command repository 32. TAT process 10 may determine that “A10 Warthog” is a call sign for aircraft 76 and “Do you see a mountain?” is a question that includes the object descriptor “mountain”.

Once TAT process 10 determines the existence of a known object descriptor (i.e., “mountain”) within the command “A10 Warthog: Do you see a mountain?”, TAT process 10 may process 158 the object descriptor (i.e., “mountain”) to associate the object descriptor with the appropriate synthetic object (e.g., synthetic object “Mountain” that is graphically represented within field of view 86 as synthetic object 52). As discussed above, TAT process 10 may associate 162 synthetic object “Mountain” with the unique color R100, G100, B100. TAT process 10 may scan 164 pilot field of view 86 for the existence of color R100, G100, B100 (i.e., the color associated with synthetic object “Mountain”).

As pilot field of view 86 is shown to include mountains 52, intelligent agent 84 would be able to “see” mountains 52. Accordingly, when TAT process 10 scans 164 field of view 86 for the existence of color R100, G100, B100 (i.e., the color associated with synthetic object “Mountain”), the color being scanned 164 for would be found.

TAT process 10 may provide 166 user 16 with positive feedback concerning the existence of the associated synthetic object (i.e., “Mountain”) within synthetic three-dimensional environment 50, such as “A10 Warthog: Affirmative”.

Upon receiving positive feedback (i.e., “A10 Warthog: Affirmative”), user 16 may continue to direct aircraft 76 toward the intended targets (i.e., tanks 70, 72, 74). As it would be more desirable to have aircraft 76 attack tanks 70, 72, 74 from the rear (as opposed to from the front), user 16 (via microphone assembly 24 included within handset 20) may issue the following command “A10 Warthog: Change heading to Heading 45°” (i.e., northeast). In response to this command, TAT process 10 change the heading of aircraft 76 to 45° (in the direction of arrow 94). TAT process 10 may acknowledge receipt of the call sign (i.e., “A10 Warthog”) and the command (i.e., “Change heading to Heading 45°”) by issuing an acknowledgement response (e.g., “A10 Warthog: Heading Changed to 45°”).

Upon receiving acknowledgement feedback (i.e., “A10 Warthog: Heading Changed to 45°”), user 16 may instruct aircraft 76 to continue flying at Heading 45° until they pass northern edge 96 of mountains 52. Upon passing the northern edge 96 of mountains 52, intelligent agent 84 may provide 166 feedback to user 16 acknowledging that the objective was accomplished. For example, TAT process 10 may acknowledge that the objective was accomplished by issuing an acknowledgement response (e.g., “A10 Warthog: Objective Accomplished”).

Upon receiving the acknowledgement response (i.e., “A10 Warthog: Objective Accomplished”), user 16 may continue to direct aircraft 76 toward the intended targets (i.e., tanks 70, 72, 74) and around mountains 52. For example, user 16 may issue the following command “A10 Warthog: Change heading to Heading 90°” (i.e., east). In response to this command, TAT process 10 change the heading of aircraft 76 to 90° (in the direction of arrow 98). TAT process 10 may acknowledge receipt of the call sign (i.e., “A10 Warthog”) and the command (i.e., “Change heading to Heading 90°”) by issuing an acknowledgement response (e.g., “A10 Warthog: Heading Changed to 90°”).

Upon receiving acknowledgement feedback (i.e., “A10 Warthog: Heading Changed to 90°”), user 16 may direct aircraft 76 to continue flying at Heading 90° until they pass the eastern face 100 of mountains 52. Upon passing the eastern face 100 of mountains 52, intelligent agent 84 may provide 166 feedback to user 16 acknowledging that the objective was accomplished. For example, TAT process 10 may acknowledge that the objective was accomplished by issuing an acknowledgement response (e.g., “A10 Warthog: Objective Accomplished”).

Upon receiving the acknowledgement response (i.e., “A10 Warthog: Objective Accomplished”), user 16 may continue to direct aircraft 76 toward the intended targets (i.e., tanks 70, 72, 74) and around mountains 52. For example, user 16 (via microphone assembly 24 included within handset 20) may issue the following command “A10 Warthog: Do you see a building?” to TAT process 10. This command includes the object descriptor “Building”.

Again, TAT process 10 may compare the various portions of this command to the various known commands defined within command repository 32. TAT process 10 may determine that “A10 Warthog” is a call sign for aircraft 76 and “Do you see a building?” is a question that includes the object descriptor “Building”.

Once TAT process 10 determines the existence of a known object descriptor (i.e., “Building”) within the command “A10 Warthog: Do you see a building?”, TAT process 10 may process 158 the object descriptor (i.e., “building”) to associate the object descriptor with the appropriate synthetic object (e.g., synthetic object “Building”). As discussed above, TAT process 10 may associate 162 synthetic object “Building” with the unique color R114, G86, B100. TAT process 10 may scan 164 the current field of view of intelligent agent 84 (e.g., field of view 102) for the existence of color R114, G86, B100 (i.e., the color associated with synthetic object “Building”). As intelligent agent 84 is looking in an easterly direction, intelligent agent 84 would not be able to “see” any buildings (e.g. buildings 62, 64). Accordingly, when TAT process 10 scans 164 field of view 102 for the existence of color R114, G86, B100 (i.e., the color associated with synthetic object “building”), the color would not be found. Since the scan 164 of synthetic three-dimensional environment 50 would fail to find color R114, G86, B100 (i.e., the color associated with synthetic object “building”), TAT process 10 may provide negative feedback to user 16, such as “A10 Warthog: Negative”.

Upon receiving negative feedback (i.e., “A10 Warthog: Negative”), user 16 (via microphone assembly 24 included within handset 20) may issue the following command “A10 Warthog: Look in a south-easterly direction”. In response to this command, intelligent agent 84 may look in a south-easterly direction, bringing buildings 62, 64 into the field of view of intelligent agent 84. TAT process 10 may acknowledge receipt of the call sign (i.e., “A10 Warthog”) and the command (i.e., “Look in a south-easterly direction”) by issuing an acknowledgement response (e.g., “A10 Warthog: Looking is a south-easterly direction”).

Upon receiving the acknowledgement response (i.e., “A10 Warthog: Looking is a south-easterly direction”), user 16 (via microphone assembly 24 included within handset 20) may again issue the following command “A10 Warthog: Do you see a building?” to TAT process 10. As discussed above, this command includes the object descriptor “building”.

Again, TAT process 10 may compare the various portions of this command to the various known commands defined within command repository 32. TAT process 10 may again determine that “A10 Warthog” is a call sign for aircraft 76 and “Do you see a building?” is a question that includes the object descriptor “building”.

Once TAT process 10 determines the existence of a known object descriptor (i.e., “building”) within the command “A10 Warthog: Do you see a building?”, TAT process 10 may process 158 the object descriptor (i.e., “building”) to associate the object descriptor with the appropriate synthetic object (e.g., synthetic object “building”). As discussed above, TAT process 10 may associate 162 synthetic object “building” with the unique color R114, G86, B100. TAT process 10 may scan 164 the current field of view of intelligent agent 84 for the existence of color R114, G86, B100 (i.e., the color associated with synthetic object “building”). As intelligent agent 84 is looking in a south-easterly direction, intelligent agent 84 would be able to “see” buildings 62, 64. Accordingly, when TAT process 10 scans 164 the south-easterly field of view for the existence of color R114, G86, B100 (i.e., the color associated with synthetic object “building”), the color would be found. Since the scan 164 of synthetic three-dimensional environment 50 would find color R114, G86, B100 (i.e., the color associated with synthetic object “building”), TAT process 10 may provide 166 positive feedback to user 16, such as “A10 Warthog: Affirmative”. However, there are two buildings, namely building 62 and building 64. Accordingly, sensing the ambiguity, intelligent agent 84 may issue a question such as “A10 Warthog: I see two buildings. Which one should I be looking at?”

Upon receiving this feedback (i.e., “A10 Warthog: I see two buildings? Which one should I be looking at?”) via e.g., speaker assembly 22, user 16 (via microphone assembly 24 included within handset 20) may issue the following command “A10 Warthog: Do you see the building on the left?”. As discussed above, building 64 is within the south-easterly field of view of intelligent agent 84, TAT process 10 may provide positive feedback to user 16, such as “A10 Warthog: Affirmative”.

Upon receiving the acknowledge response (i.e., “A10 Warthog: Affirmative”), user 16 may continue to direct aircraft 76 toward the intended targets (i.e., tanks 70, 72, 74). For example, user 16 may issue the following command “A10 Warthog: Change heading to Heading 202.5°” (i.e., south-southwest). In response to this command, TAT process 10 may change the heading of aircraft 76 to 202.5° (in the direction of arrow 104). TAT process 10 may acknowledge receipt of the call sign (i.e., “A10 Warthog”) and the command (i.e., “Change heading to Heading 202.5°”) by issuing an acknowledgement response (e.g., “A10 Warthog: Heading Changed to 202.5°”).

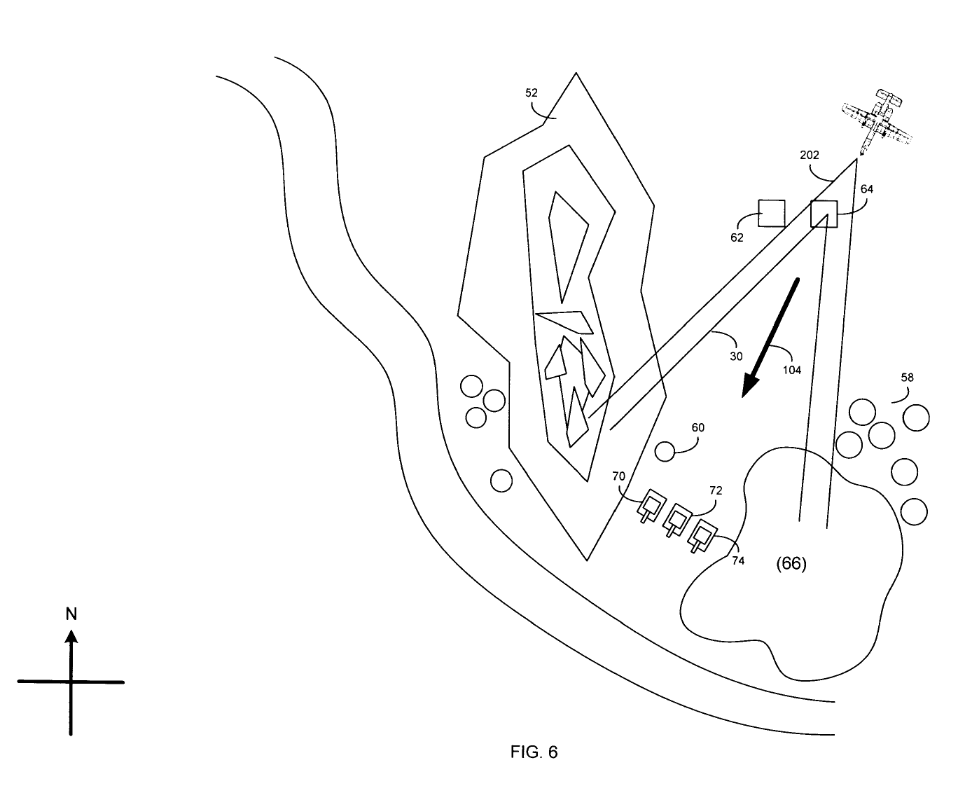

Referring also to FIGS. 6 & 7, once traveling in a south-southwest direction (i.e., in the direction of arrow 104), field of view 202 may be established for intelligent agent 84. Upon receiving feedback (i.e., “A10 Warthog: Heading Changed to 202.5°”), user 16 (via microphone assembly 24 included within handset 20) may issue the following command “A10 Warthog: Do you see three T-54 tanks?” to TAT process 10. As discussed above, this command includes the object descriptor “T-54”.

Again, TAT process 10 may compare the various portions of this command to the various known commands defined within command repository 32. TAT process 10 may determine that “A10 Warthog” is a call sign for aircraft 76 and “Do you see three T-54 tanks??” is a question that includes the object descriptor “T-54”.

Once TAT process 10 determines the existence of a known object descriptor (i.e., “T-54”) within the command “A10 Warthog: Do you see three T-54 tanks?”, TAT process 10 may process 158 the object descriptor (i.e., “T-54”) to associate the object descriptor with the appropriate synthetic object (e.g., synthetic object “T54” that is graphically represented within field of view 202 as synthetic objects 70, 72, 74). As discussed above, TAT process 10 may associate 162 synthetic object “T-54” with the unique color R255, G0, B0. TAT process 10 may scan 164 pilot field of view 202 for the existence of color R255, G0, B0 (i.e., the color associated 162 with synthetic object “T54”).

As pilot field of view 202 is shown to include tanks 70, 72, 74, intelligent agent 84 would be able to “see” tanks 70, 72, 74. Accordingly, when TAT process 10 scans 164 field of view 202 for the existence of color R255, G0, B0 (i.e., the color associated with synthetic object “T54”), the color would be found.

TAT process 10 may provide 166 user 16 with positive feedback concerning the existence of the associated synthetic object (i.e., “T54”) within synthetic three-dimensional environment 50, such as “A10 Warthog: Affirmative”.

Upon receiving the acknowledgement response (i.e., “A10 Warthog: Affirmative”), user 16 may direct aircraft 76 to engage the targets (i.e., tanks 70, 72, 74). For example, user 16 may issue the following command “A10 Warthog: Engage three T-54 tanks. At this point, intelligent agent 84 may engage tanks 70, 72, 74 with e.g., a combination of weapons available on aircraft 76 (e.g., a General Electric GAU-8/A Avenger gatling gun and/or AGM-65 Maverick air-to-surface missiles).

While TAT process 10 is described above as allowing user 16 to be trained in the procedures required to locate a target for engagement by e.g., an aircraft, a tank, or a boat, other configurations are possible and are considered to be within the scope of this disclosure. For example, TAT process 10 may be a video game (or a portion thereof) that is executed on a personal computer (e.g., computing device 12) or a video game console (e.g., a Sony Playstation III and a Nintendo Wii; not shown) and provides personal entertainment to e.g., user 16.

While synthetic three-dimensional environment 50 is described above as being static and generic, other configurations are possible and are considered to be within the scope of this disclosure. For example, synthetic three-dimensional environment 50 may be configured to at least partially model a real-world three-dimensional environment (e.g., one or more past, current, and/or potential future theaters of war). For example, synthetic three-dimensional environment 50 may be configured to replicate Omaha Beach on 6 Jun. 1944 during the Normandy Invasion; Fallujah, Iraq during Operation Phantom Fury in 2004; and/or Pyongyang, North Korea.

Additionally and referring again to FIG. 1, computing device 12 (e.g., a laptop computer, a notebook computer, a single server computer, a plurality of server computers, a desktop computer, or a handheld device, for example) may be coupled to distributed computing network 106, examples of which may include but are not limited to the internet, an intranet, a wide area network, and a local area network. Via network 106, computing device 12 may receive one or more updated synthetic objects (e.g., objects 52, 54, 56, 58, 60, 62, 64, 66, 68, 70, 72, 74, 76) that TAT process 10 may use to update 172 (FIG. 3) synthetic three-dimensional environment 50 to reflect one or more real-world events. For example, suppose that synthetic three-dimensional environment 50 is designed to model downtown Baghdad, Iraq. Further, assume that a bridge over the Tigris river is destroyed due to a U.S. air strike. TAT process 10 may obtain from e.g., a remote computer (not shown) coupled to network 106 an updated synthetic object. As discussed above, a synthetic object is a three-dimensional object that defines a three-dimensional space within synthetic three-dimensional environment 50. Accordingly, the updated synthetic object (for the destroyed bridge over the Tigris river) that is obtained by TAT process 10 may be a three-dimensional representation of a destroyed bridge. TAT process 10 may use this updated synthetic object (i.e., the synthetic object of a destroyed bridge) to replace the original synthetic object (i.e., the synthetic object of the non-destroyed bridge) within synthetic three-dimensional environment 50. Accordingly, by updating 172 synthetic three-dimensional environment 50 to include one or more updated synthetic objects, synthetic three-dimensional environment 50 may be updated to reflect one or more real-world events (e.g., the destruction of a bridge).

A number of implementations have been described. Nevertheless, it will be understood that various modifications may be made. Accordingly, other implementations are within the scope of the following claims.

What is claimed is:

1. A method comprising:
receiving an object descriptor from a user;
processing the object descriptor to associate the object descriptor with one of a plurality of synthetic objects, thus defining an associated synthetic object;
scanning at least a portion of a synthetic three-dimensional environment for the existence of the associated synthetic object; and
providing feedback to the user concerning the existence of the associated synthetic object within the synthetic three-dimensional environment.

2. The method of claim 1 wherein the synthetic three-dimensional environment is configured to at least partially model a real-world three-dimensional environment.

3. The method of claim 2 further comprising:
updating the synthetic three-dimensional environment to reflect one or more real-world events.

4. The method of claim 1 wherein the object descriptor is an analog speech-based object descriptor, and wherein processing the object descriptor includes:
converting the analog speech-based object descriptor into a digital object descriptor.

5. The method of claim 1 wherein the feedback is digital feedback, and wherein providing feedback to the user includes:
converting the digital feedback into analog speech-based feedback; and
providing the analog speech-based feedback to the user.

6. The method of claim 1 wherein the synthetic three-dimensional environment includes a plurality of unique synthetic objects, wherein each unique synthetic object is associated with a unique characteristic.

7. The method of claim 6 wherein the unique characteristic is a unique color.

8. The method of claim 1 wherein processing the object descriptor includes:
associating the associated synthetic object with one of a plurality of unique colors, thus defining an associated unique color.

9. The method of claim 8 wherein scanning at least a portion of the synthetic three-dimensional environment for the existence of the associated synthetic object includes:
scanning at least a portion of the synthetic three-dimensional environment for the existence of the associated unique color.

10. The method of claim 1 wherein at least one of the plurality of synthetic objects is representative of one or more topographical objects.

11. The method of claim 10 wherein the one or more topographical objects includes at least one man-made object.

12. The method of claim 10 wherein the one or more topographical objects includes at least one natural object.

13. A computer program product residing on a computer readable medium having a plurality of instructions stored thereon which, when executed by a processor, cause the processor to perform operations comprising:
receiving an object descriptor from a user;
processing the object descriptor to associate the object descriptor with one of a plurality of synthetic objects, thus defining an associated synthetic object;
scanning at least a portion of a synthetic three-dimensional environment for the existence of the associated synthetic object; and
providing feedback to the user concerning the existence of the associated synthetic object within the synthetic three-dimensional environment.

14. The computer program product of claim 13 wherein the synthetic three-dimensional environment is configured to at least partially model a real-world three-dimensional environment.

15. The computer program product of claim 14 further comprising instructions for:
updating the synthetic three-dimensional environment to reflect one or more real-world events.

16. The computer program product of claim 13 wherein the object descriptor is an analog speech-based object descriptor, and wherein the instructions for processing the object descriptor include instructions for:
converting the analog speech-based object descriptor into a digital object descriptor.

17. The computer program product of claim 13 wherein the feedback is digital feedback, and wherein the instructions for providing feedback to the user include instructions for:
converting the digital feedback into analog speech-based feedback; and
providing the analog speech-based feedback to the user.

18. The computer program product of claim 13 wherein the synthetic three-dimensional environment includes a plurality of unique synthetic objects, wherein each unique synthetic object is associated with a unique characteristic.

19. The computer program product of claim 18 wherein the unique characteristic is a unique color.

20. The computer program product of claim 13 wherein the instructions for processing the object descriptor include instructions for:
associating the associated synthetic object with one of a plurality of unique colors, thus defining an associated unique color.

21. The computer program product of claim 20 wherein the instructions for scanning at least a portion of the synthetic three-dimensional environment for the existence of the associated synthetic object include instructions for:
scanning at least a portion of the synthetic three-dimensional environment for the existence of the associated unique color.

22. The computer program product of claim 13 wherein at least one of the plurality of synthetic objects is representative of one or more topographical objects.

23. The computer program product of claim 22 wherein the one or more topographical objects includes at least one man-made object.

24. The computer program product of claim 22 wherein the one or more topographical objects includes at least one natural object.

25. A target acquisition system comprising:
a display screen;
a microphone assembly; and
a data processing system coupled to the display screen and the microphone assembly, the data processing system being configured to:
render, on the display screen, a first-party view of a synthetic three-dimensional environment for a user;
receive, via the microphone assembly, an analog speech-based object descriptor from the user;
process the analog speech-based object descriptor to associate the analog speech-based object descriptor with one of a plurality of synthetic objects, thus defining an associated synthetic object;
scan a second-party view of the synthetic three-dimensional environment for the existence of the associated synthetic object; and
provide analog speech-based feedback to the user concerning the existence of the associated synthetic object within the second-party view of the synthetic three-dimensional environment.

26. The target acquisition system of claim 25 wherein the synthetic three-dimensional environment includes a plurality of unique synthetic objects, wherein each unique synthetic object is associated with a unique characteristic.

27. The target acquisition system of claim 26 wherein the unique characteristic is a unique color.

28. The target acquisition system of claim 25 wherein processing the analog speech-based object descriptor includes:
associating the associated synthetic object with one of a plurality of unique colors, thus defining an associated unique color.

29. The target acquisition system of claim 28 wherein scanning the second-party view of the synthetic three-dimensional environment for the existence of the associated synthetic object includes:
scanning the second-party view of the synthetic three-dimensional environment for the existence of the associated unique color.

30. The target acquisition system of claim 25 wherein at least one of the plurality of synthetic objects is representative of one or more topographical objects.

31. The target acquisition system of claim 30 wherein the one or more topographical objects includes at least one man-made object.

32. The target acquisition system of claim 30 wherein the one or more topographical objects includes at least one natural object.
